(19) United States
(12) Patent Application Publication
(10) Pub. No.: US 2007/0006324 A1
(43) Pub. Date: Jan. 4, 2007

(54) IMAGE FORMING METHOD, IMAGE FORMING SYSTEM, IMAGE FORMING APPARATUS, DRIVER PROGRAM, INFORMATION PROCESSING APPARATUS, AND LICENSE MANAGEMENT SERVER

(75) Inventors: MAMORU OSADA, Kawasaki-shi (JP); Tsutomu Kubota, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/425,994

(22) Filed: Jun. 22, 2006

(30) Foreign Application Priority Data
Jun. 30, 2005 (JP) 2005-193080

(51) Int. Cl. H04L 9/32

(52) U.S. Cl. 726/27

(57) ABSTRACT

This invention provides a system to solve a problem that in outputting print data from another device by using a storage medium storing a print job, the obtained result changes depending on the difference in environment. In this system, device configuration information necessary for processing an image is stored in the storage medium simultaneously with storage of the print job. The device configuration information contains a software application and license to process an image. That is, in storing a job in the storage medium, the temporary license of a software application necessary for the job is stored together. When another copying machine reads out the job from the storage medium to execute it, a formal license is acquired from a server by using the temporary license. The job is properly executed by using the application on the basis of the formal license.

### FIELD OF THE INVENTION

The present invention relates to an image forming method, image forming system, image forming apparatus, driver program, information processing apparatus, and license management server.

### BACKGROUND OF THE INVENTION

Image forming methods and apparatuses to form an image by using a software application that requires a license are known conventionally. There exist, e.g., printers and copying machines which install and execute a software application, as needed, by using Java® or the like.

For example, a technique is known which manages, on a predetermined server on the basis of a license, a software application to execute specific processing and causes an office equipment in an arbitrary location to download and execute the application any time (patent reference 1).

On the other hand, there is a need for storing, in a storage medium, a print job generated by using a given device and causing another device to output it equally as in the device used for generation.

[Patent Reference 1] Japanese Patent Laid-Open No. 2000-330784

The conventional image forming methods and apparatuses however require a license to use a software application. For this reason, even when a job that is executable by a specific application is input to another device incapable of using the application, the job cannot be executed.

That is, license management is done for a software application. A print job created by using a predetermined application can be executed only by a device that can use the same application. To execute the created job in another device, the same printing environment including the application must be prepared.

### SUMMARY OF THE INVENTION

The present invention has been made to solve the problem of the above-described prior art, and has as its object to allow a device to execute a job in the same environment as that for another device used for creation of the job.

According to an aspect of the present invention, there is provided an image forming method of executing image forming by using a software application which requires a license for use, comprising the steps of:

issuing a temporary license for a print job which requires the application, in a first apparatus;

storing the temporary license in a storage medium of the first apparatus;

reading out the temporary license from the storage medium and causing a second apparatus to acquire a license from a server in exchange for the temporary license; and

executing the print job in the second apparatus by using the application whose license is acquired in the reading step.

According to another aspect of the present invention, there is provided an image forming system including a first image forming apparatus and a second image forming apparatus, wherein

the first image forming apparatus comprises

a software application usable on condition of a first license,

generation means for generating a print job to be implemented by using the application, and

storage means for storing, in a storage medium, a temporary license for the print job generated by the generation means and a temporary license for the application; and

the second image forming apparatus comprises

means for reading out the temporary license from the storage medium which stores the print job,

means for requesting a second license necessary for using the application of a server by using the temporary license, and

means for acquiring the second license and executing the print job by using the application.

According to still another aspect of the present invention, there is provided a driver program to instruct a first image forming apparatus used in the above-described image forming system to output a print job to a storage medium, causing a computer to execute the step of setting contents to be transferred from contents of a first license to a second license in instructing output of image data.

There is provided an image forming apparatus comprising:

a software application usable on condition of a first license;

generation means for generating a print job to be implemented by using the application;

storage means for storing, in a storage medium, the print job generated by the generation means and a temporary license for the application;

means for reading out the temporary license from the storage medium which stores the print job;

means for requesting a second license necessary for using the application of a server by using the temporary license; and

means for acquiring the second license and executing the print job by using the application.

According to still another aspect of the present invention, there is provided a driver program to cause an image forming apparatus to execute image forming by using a software application which requires a license for use, causing a computer to execute the steps of:

requesting the image forming apparatus to issue a temporary license when a print job which requires the application is stored in a storage medium;

receiving the temporary license issued in response to the request from the image forming apparatus; and

adding the received temporary license to the print job and storing the temporary license in the storage medium.

According to still another aspect of the present invention, there is provided an information processing apparatus for causing an image forming apparatus to execute image forming by using a software application which requires a license for use, comprising:

temporary license request means for requesting the image forming apparatus to issue a temporary license when a print job which requires the application is stored in a storage medium;

reception means for receiving the temporary license issued in response to the request from the image forming apparatus; and

storage means for adding the received temporary license to the print job and storing the temporary license in the storage medium.

According to still another aspect of the present invention, there is provided a license management server comprising:

a license identification information database which manages a software application, license identification information to identify a license issued by normal license issue processing, and license identification information to identify a license generated from a temporary license; and

generation means for generating a formal license from the temporary license,

wherein upon receiving a software application request command from an image forming apparatus connected through a network, the generation means determines whether original license identification information and the temporary license identification information, which are contained in the temporary license sent in accordance with the application request command, are present in the license identification information database,

only when the original license identification information is registered in the license identification information database, and the temporary license identification information is not registered, the generation means generates a formal license having the same identification information as the temporary license, and

the generation means stores the identification information of the generated formal license in the license identification information database and returns the formal license to the image forming apparatus together with the application.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a view showing the system configuration of an image forming apparatus according to the first embodiment of the present invention;

FIG. 2 is a system block diagram of the image forming apparatus according to the first embodiment of the present invention;

FIG. 3 is a software block diagram of the image forming apparatus according to the first embodiment of the present invention;

FIG. 4 is a flowchart executed when a print job is received in the image forming apparatus according to the first embodiment of the present invention;

FIG. 5 is a flowchart of device configuration information generation of the image forming apparatus according to the first embodiment of the present invention;

FIG. 6 is a view showing the license information of a specific application in the image forming apparatus according to the first embodiment of the present invention;

FIG. 7 is a view showing device configuration information generated by the image forming apparatus according to the first embodiment of the present invention;

FIG. 8 is a view showing a temporary license generated by the image forming apparatus according to the first embodiment of the present invention;

FIG. 9 is a software block diagram of the image forming apparatus according to the first embodiment of the present invention;

FIG. 10 is a flowchart executed when a memory card is inserted in the image forming apparatus according to the first embodiment of the present invention;

FIG. 11 is a view showing part of the database of a license server according to the first embodiment of the present invention;

FIG. 12 is a flowchart of the license server according to the first embodiment of the present invention;

FIG. 13 is a view of a license issued by the license server according to the first embodiment of the present invention;

FIG. 14 is a view showing the license transfer processing window of a driver according to the first embodiment of the present invention;

FIG. 15 is a flowchart executed when a print job is received in an image forming apparatus according to the second embodiment of the present invention;

FIG. 16 is a view showing the configuration of a system according to the third embodiment of the present invention;

FIG. 17 is a view showing the configurations of MFPs 110 and 120 and a PC 101 according to the third embodiment of the present invention;

FIG. 18 is a flowchart showing the operation of the PC 101 according to the third embodiment of the present invention;

FIG. 19 is a flowchart showing the print data creation operation of the MFP 110 according to the third embodiment of the present invention;

FIG. 20 is a flowchart showing the print operation of the MFP 120 according to the third embodiment of the present invention;

FIG. 21 is a flowchart showing the operation of a PC 101 according to the fourth embodiment of the present invention;

FIG. 22A is a flowchart of the print operation of an MFP 120 according to the fourth embodiment of the present invention;

FIG. 22B is a flowchart of the print operation of the MFP 120 according to the fourth embodiment of the present invention; and

FIG. 23 is a view showing the configuration of a system according to the fifth embodiment of the present invention.

### DETAILED DESCRIPTION OF THE PREFERRED EMBODIMENTS

Preferred embodiments of the present invention will now be described in detail with reference to the accompanying drawings. It should be noted that the relative arrangement of the components, the numerical expressions and numerical values set forth in these embodiments do not limit the scope of the present invention unless it is specifically stated otherwise.

### First Embodiment

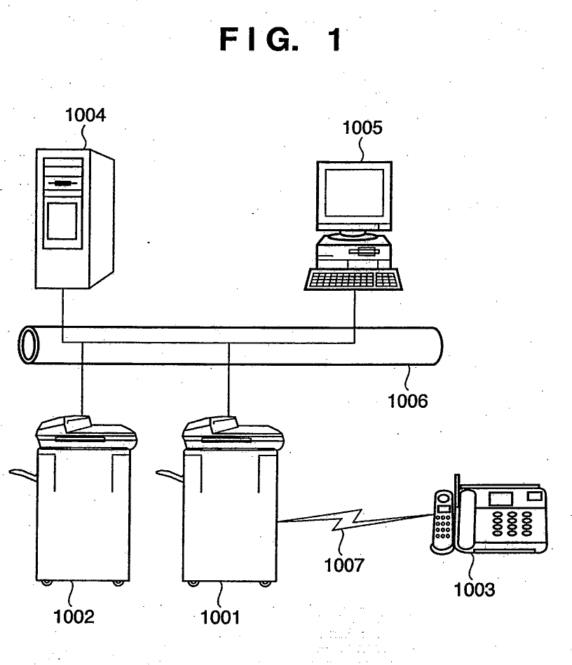

FIG. 1 is a view showing a system configuration including a copying machine as the first embodiment of an image forming apparatus according to the present invention.

Copying machines 1001 and 1002 serving as first and second image forming apparatuses have functions of reading a document and printing an image or transmitting it to various devices. A facsimile apparatus 1003 receives, through a public line 1007, data read by the copying machine 1001 and prints the data. A database/license server 1004 is a computer to manage the licenses of applications that run on the copying machines 1001 and 1002. A client computer 1005 instructs the copying machines 1001 and 1002 to do printing. An Ethernet® 1006 is a network which connects the copying machines 1001 and 1002, database/license server 1004, and client computer 1005 to each other.

The copying machines 1001 and 1002 exist in different offices or remote sites. Both the copying machines 1001 and 1002 can access the database/license server 1004 through the Ethernet® 1006. Any connection medium capable of two-way communications can be used. The protocol used on the connection medium for data transmission/reception between the copying machines 1001 and 1002, the database server 1004, and the client computer 1005 can be either an existing protocol such as HTTP (Hyper Text Transfer Protocol), SOAP (Simple Object Access Protocol), or FTP (File Transfer Protocol) or a unique application protocol. A plurality of client computers may be connected to the Ethernet® 1006.

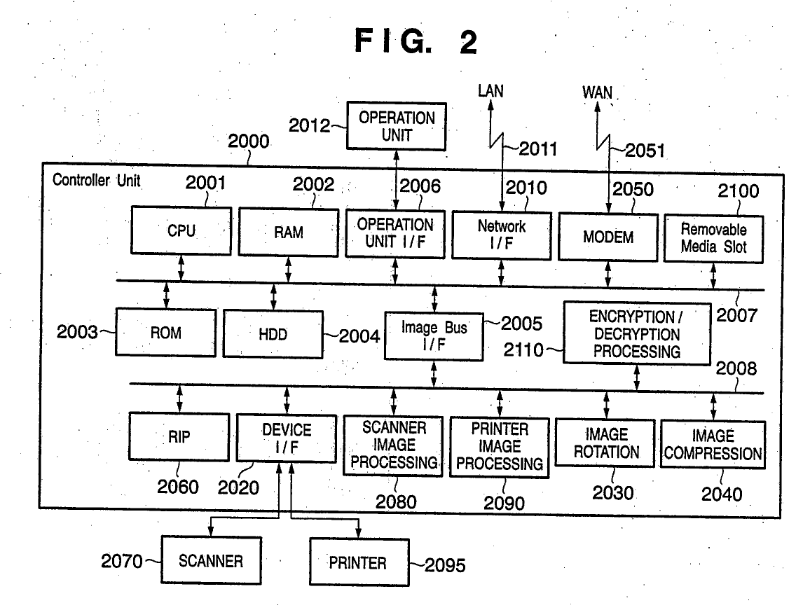

FIG. 2 is a block diagram showing the internal configuration of the copying machines 1001 and 1002. A controller unit 2000 is connected to a scanner 2070 serving as an image input device and a printer 2095 serving as an image output device and also connected to a LAN 2011 and public line (WAN) 2051 so as to input/output image information or device information.

A CPU 2001 is a controller to control the entire system. A RAM 2002 serves as a system work memory to make the CPU 2001 operate, an image memory to temporarily store image data, or a work memory on which various kinds of applications are executed. A ROM 2003 is a boot ROM which stores the boot program of the system. An HDD (Hard Disk Drive) 2004 stores system software, image data, various kinds of applications, and the log of various jobs processed in the copying machine. An operation unit interface 2006 interfaces an operation unit (UI) 2012 having a touch panel and outputs display image data to the operation unit 2012. The operation unit interface 2006 also transmits, to the CPU 2001, information input by the system user through the operation unit 2012.

A network interface 2010 is connected to the LAN 2011 to input/output information. A modem 2050 is connected to the public line 2051 to input/output information. The above-described devices are arranged on a system bus 2007.

An image bus interface 2005 is a bus bridge which connects the system bus 2007 to an image bus 2008 for transferring image data at a high speed and converts the data structure. The image bus 2008 is formed from a PCI bus or IEEE1394. The following devices are arranged on the image bus 2008. A raster image processor (RIP) 2060 rasterizes a PDL code to a bitmap image.

A device interface 2020 connects the scanner 2070 and printer 2095 serving as image input/output devices to the controller unit 2000 and converts image data synchronous/asynchronous system. A scanner image processing unit 2080 corrects, manipulates, and edits input image data. A printer image processing unit 2090 executes, e.g., correction and resolution conversion of the printer for print output image data. An image rotation unit 2030 rotates image data.

An image compression unit 2040 executes compression/decompression processing such as JPEG for multilevel image data and JBIG, MMR, and MH for binary image data. A removable media slot 2100 can connect a detachable data saving medium (storage medium) such as a memory card and store or read image data. In this embodiment, a memory card is used as a storage medium. An encryption/decryption processing unit 2110 is a hardware accelerator board which executes data encryption/decryption processing by using, e.g., a predetermined key.

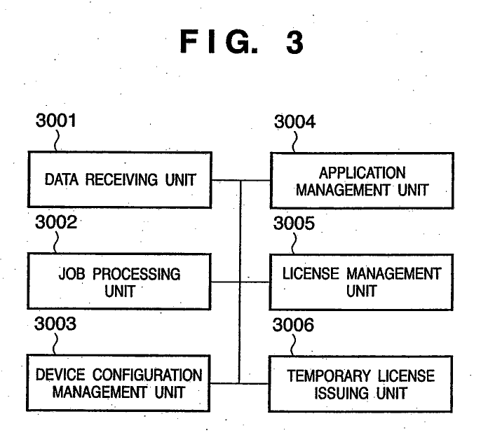

FIG. 3 is a block diagram showing the software configuration in the copying machine 1001. A data receiving unit 3001 receives, e.g., a print job requested by the client computer 1005. A job processing unit 3002 manages and executes various jobs to be executed on the copying machine 1001, including a received print job. A device configuration management unit 3003 manages device configuration information necessary for execution of a job. Depending on the contents of a job, the device configuration management unit 3003 notifies the job processing unit 3002 of device configuration information used in the job.

A software application management unit 3004 manages applications to be used for job execution by the job processing unit 3002. The application management unit 3004 manages applications and their life cycles to install/uninstall a software application and license or activate or stop a software application. A license management unit 3005 manages a valid period and the upper limit of use count which are set for each application. A temporary license issuing unit 3006 generates and issues a temporary license from a predetermined license in the license management unit 3005 in accordance with a request from the device configuration management unit 3003.

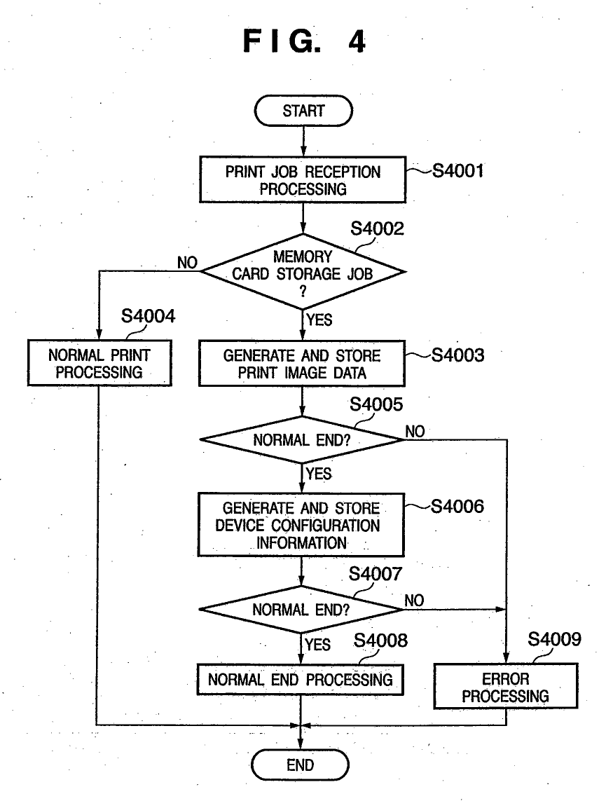

FIG. 4 is a flowchart showing processing executed when the copying machine 1001 or 1002 receives a print job from the client computer 1005. First, in step S4001, the data receiving unit 3001 receives a print job from the client computer 1005.

In step S4002, the copying machine 1001 or 1002 determines whether the received job instructs storage on a memory card inserted in the removable media slot 2100. If YES in step S4002, the flow advances to step S4003. Otherwise, the job processing unit 3002 executes normal print processing in step S4004. In step S4003, the copying machine 1001 or 1002 generates image data and stores it on the memory card in accordance with the contents of the print job. The flow advances to step S4005. The copying machine 1001 or 1002 determines whether image data generation/storage is executed normally. If YES in step S4005, the flow advances to step S4006. Otherwise, the flow advances to step S4009. In step S4006, the copying machine 1001 or 1002 acquires device configuration information for print job execution from the device configuration management unit 3003 and stores the information.

In step S4007, it is determined whether the processing in step S4006 is normally ended. If YES in step S4007, the flow advances to step S4008 to execute normal end processing. Otherwise, the flow advances to step S4009 to execute error end processing. The error end processing includes, e.g., deleting various kinds of data stored on the memory card.

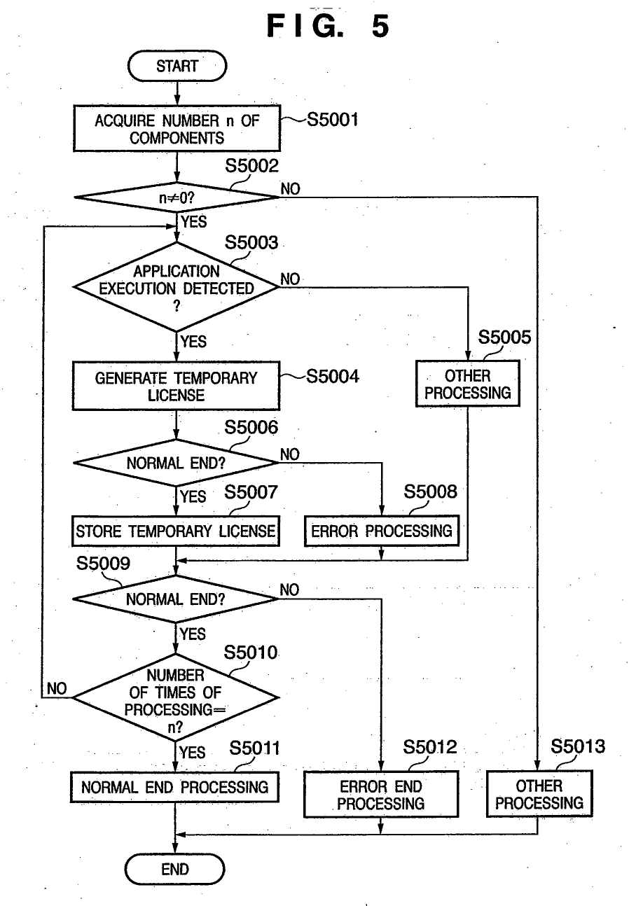

FIG. 5 is a flowchart showing device configuration information generation/storage processing in step S4006 in FIG. 4.

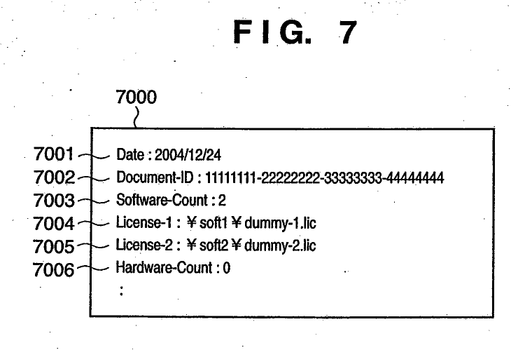

In step S5001, the number of components of a device necessary for image data generation for a job executed in step S4003 is acquired from the device configuration management unit 3003. The number of components of a device necessary for image data generation indicates the number of components of a device necessary for job execution. The device indicates a software application or hardware (FIG. 7). In step S5002, it is determined whether the number of components is not 0. If no component is present, other processing is executed in step S5013, and the flowchart is ended. If a component is present, the flow advances to step S5003 to detect whether a software application is executed at the time of image data generation. If YES in step S5003, the flow advances to step S5004. Otherwise, the flow advances to step S5005 to execute other processing. In step S5004, a temporary license for the application is generated. More specifically, a license corresponding to the application is acquired from the license management unit 3005. Temporary license issue processing is required of the temporary license issuing unit 3006.

In step S5006, it is determined whether temporary license generation is normally ended. If YES in step S5006, the flow advances to step S5007. Otherwise, the flow advances to step S5008. In step S5007, the temporary license is stored on the memory card. Storage destination information is stored in the device configuration information. With this configuration, when a data saving medium is connected to an arbitrary image forming apparatus, a license to properly use a software application can always be carried.

In step S5008, error processing is executed, in which the temporary license generated in step S5004 is, e.g., deleted. In step S5009, it is determined whether the processing from step S5003 is normally ended. If YES in step S5009, the flow advances to step S5010. Otherwise, the flow advances to step S5012.

In step S5010, it is determined whether the processing is executed n times, i.e., as many times as the number of components acquired in step S5001. If the processing is not completed, the flow returns to step S5003 to repeat the above-described processing. If the processing is completed, the flow advances to step S5011. In step S5011, normal end processing is executed. In step S5012, error end processing is executed.

In this embodiment, in storing the temporary license in step S5007, the encryption/decryption processing unit 2110 executes encryption by using a predetermined encryption key. In this case, the security of license information of the data saving medium can be increased.

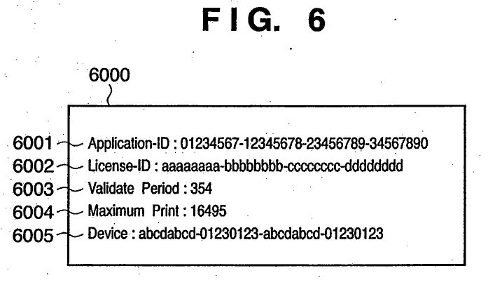

FIG. 6 shows license information 6000 of a specific application, which is managed by the license management unit 3005 according to this embodiment. The license management unit 3005 has the license information 6000 corresponding to each application. Reference numeral 6001 denotes application identification information to uniquely identify a software application. In this embodiment, UUID (Universal Unique ID) is added to each application as information to uniquely identify it. The application identification information 6001 is the same as the UUID.

License identification information 6002 is uniquely assigned to a license. In this embodiment, UUID is used. Valid period information 6003 indicates a period during which the application can be used on the basis of the license. In this embodiment, the license is valid for 354 days. Printing upper limit information 6004 indicates the upper limit of the printed sheet count of the application based on the license. In this embodiment, the remaining sheet count is 16,495. Device identification information 6005 uniquely identifies the copying machine 1001. In this embodiment, UUID is used.

In this embodiment, UUTD is used as information to uniquely identify the device. However, the format is not limited to UUID if the information can uniquely identify the device. The license information may be managed in a text format, and any other format such as binary data or XML data can be used as the holding format. When the temporary license is defined by identification information, the application can be prevented from being used for other than its original purpose, and the license can be managed more strictly.

FIG. 7 shows part of device configuration information 7000 generated in step S4006 of this embodiment. Reference numeral 7001 denotes a date of configuration information generation; 7002, image data identification information created in the device configuration information 7000. In this embodiment, UUID is used. Reference numeral 7003 denotes the number of pieces of application information contained in the device configuration information 7000. In this embodiment, two applications are associated. Reference numeral 7004 denotes a temporary license of the first application and a location where the temporary license is stored. Reference numeral 7005 denotes a temporary license of the second application and a location where the temporary license is stored. Reference numeral 7006 denotes the number of pieces of hardware configuration information contained in the device configuration information 7000.

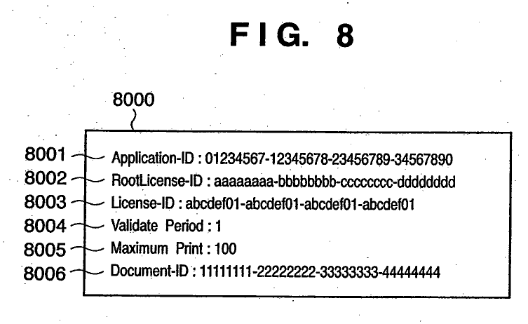

FIG. 8 shows information of a temporary license 8000 generated in step S5004. Reference numeral 8001 denotes identification information of a software application corresponding to the temporary license 8000; 8002, identification information of an original license, i.e., the first license whose contents have been transferred; and 8003, information to uniquely identify the temporary license 8000. Valid period information 8004 indicates a period during which the application can be used on the basis of the license. In this embodiment, the license is valid for one day. Printing upper limit information 8005 indicates the upper limit of the printed sheet count of the application based on the license. In this embodiment, the remaining sheet count is 100. Reference numeral 8006 denotes identification information of image data that can be processed by the license.

In generating a temporary license by the temporary license issuing unit 3006, the temporary license 8000 is generated from the license information 6000. At this time, the valid period information 8004 and printing upper limit information 8005 described in the temporary license 8000 are subtracted from the valid period information 6003 and printing upper limit information 6004 of the license information 6000. Hence, the application can be used in another image forming apparatus within the license given to the application of the image forming apparatus.

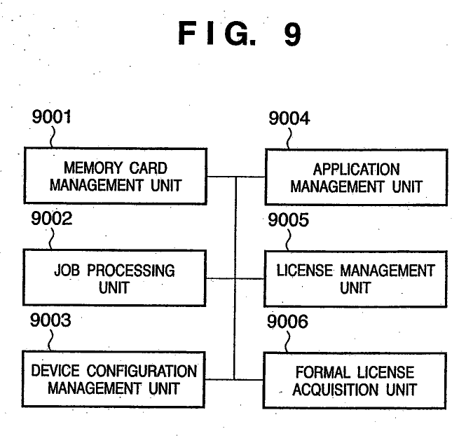

Processing of uploading data stored on a memory card in the copying machine 1001 to the copying machine 1002 will be described next. FIG. 9 is a block diagram showing the software configuration of the copying machine 1002.

A memory card management unit 9001 controls a memory card inserted in the removable media slot 2100. Upon detecting insertion of a memory card, the memory card management unit 9001 searches for the device configuration information 7000 and image data and executes predetermined processing. A job processing unit 9002 manages and executes various jobs to be executed on the copying machine 1001, including printing of image data stored on the memory card. A device configuration management unit 9003 compares information in the device configuration information 7000 detected by the memory card management unit 9001 with current device configuration and detects the difference. A software application management unit 9004 manages applications to be used for job execution by the job processing unit 9002 on the copying machine 1002. The application management unit 9004 manages applications and their life cycles to install/uninstall a software application and license or activate or stop a software application. A license management unit 9005 manages a valid period and the upper limit of use count which are set for each application. A formal license acquisition unit 9006 requests and acquires a formal license from the license server 1004 on the basis of the temporary license contained in the device configuration information 7000 sent from the memory card management unit 9001.

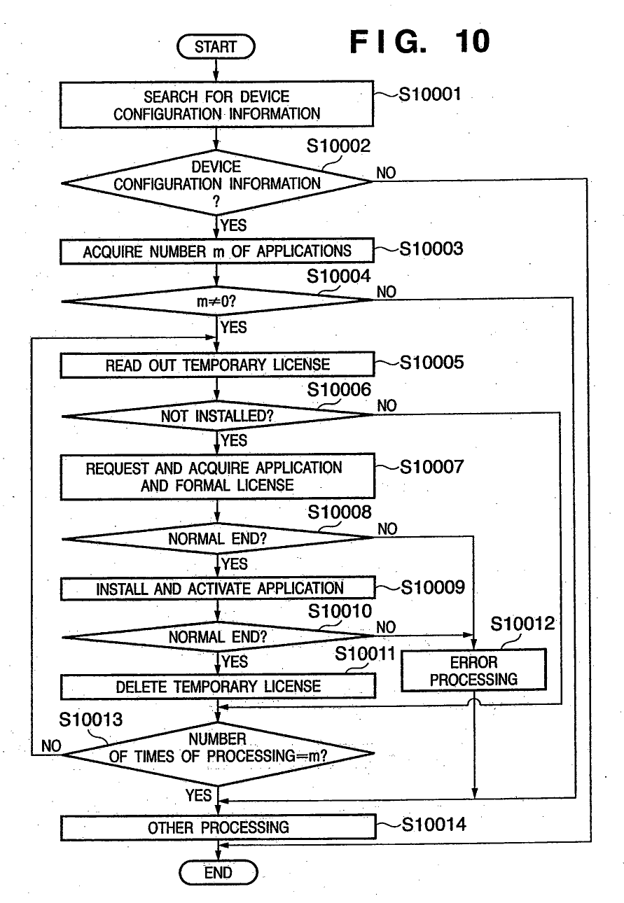

FIG. 10 is a flowchart showing processing of the memory card management unit 9001 which is executed when a memory card is inserted in the copying machine 1002 of this embodiment.

In step S10001, the device configuration information 7000 is searched from the memory card. In this embodiment, the file name and extension of the device configuration information 7000 are not particularly limited if it is searchable information stored in a predetermined format. In step S10002, it is determined whether the device configuration information 7000 is found as the result of search in step S10001. If YES in step S10002, the flow advances to step S10003. Otherwise, the processing of this flow is ended. In step S10003, the application information count 7003 in the device configuration information 7000 is acquired.

In step S10004, it is determined whether the application information count 7003 is not 0. If the application information count 7003 is not 0, the flow advances to step S10005. If the application information count 7003 is 0, the flow advances to step S10014. In step S10005, the temporary license storage information 7005 is analyzed, and the temporary license 8000 is read out from a predetermined position on the memory card. In this step, the encryption/decryption processing unit 2110 executes decryption by using a predetermined decryption key. In this step, additionally, the application identification information 8001 to uniquely identify the application is acquired from the temporary license 8000.

In step S10006, it is determined whether the application identification information acquired in step S10005 is already installed in the application management unit 3004. If the identification information is not installed, the flow advances to step S10007. Otherwise, the flow advances to step S10013.

In step S10007, a formal license is acquired as the second license. More specifically, the temporary license and the identification information of the copying machine 1002 are transmitted to the license server 1004 on the network through the formal license acquisition unit 9006, thereby acquiring the application and formal license. In this embodiment, the identification information of the copying machine 1002 is abcdabcd-45674567-abcdabcd-45674567.

In step S10008, it is determined whether the application and formal license are acquired successfully. If YES in step S10008, the flow advances to step S10009. Otherwise, the flow advances to step S10012. In step s10009, the application is installed and activated. That is, the application is installed and activated by using the application and formal license acquired in step S10007. In the copying machine 1002 of this embodiment, the minimum necessary conditions are the coincidence between the application identification information held by the application to be installed and the application identification information in the license, the presence of license identification information, and the coincidence between the device identification information and the device identification information of the copying machine 1002.

The flow advances to step S10010 to determine whether installation/activation processing is executed successfully. If YES in step S10010, the flow advances to step S10011. Otherwise, the flow advances to step S10012. In step S10011, the temporary license 8000 on the memory card is deleted to prevent execution of the same processing using the memory card.

In step S10012, error processing is executed. More specifically, various kinds of information read out from the memory card are cleared or displayed on the operation unit 2012 of the copying machine 1002. When this step is ended, the flow advances to step S10014.

In step S10013, it is determined whether the processing is executed as many times as the number indicated by the application information count 7003 in the device configuration information 7000. If the processing is not completed, the flow returns to step S10005 to continue the processing. Otherwise, the flow advances to step S10014 to execute other processing, and the processing of this flowchart is ended.

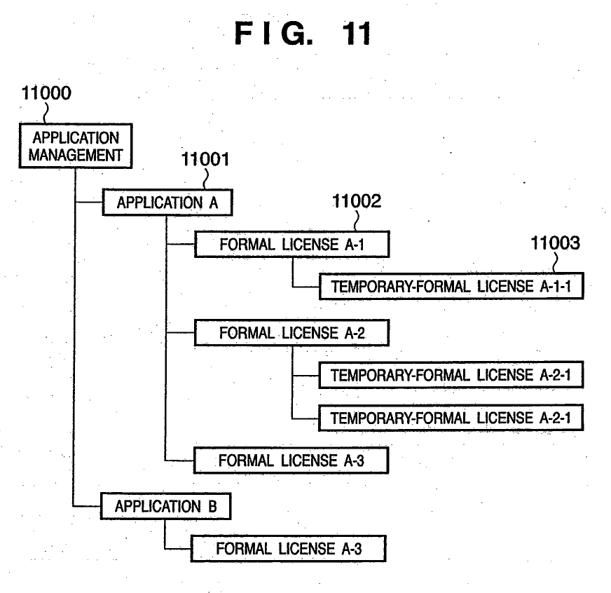

FIG. 11 shows part of the DB which manages applications and licenses in the license server 1004. In this embodiment, only license management will be described, though any other function may be included. The data holding format of the illustrated contents in the DB is not particularly limited.

Information 11000 indicates the root of application management information of this embodiment. Information in this DB is searched from this information as needed. Application information 11001 stores information about a software application such as a software application name and information to uniquely identify the application. Formal license information 11002 stores information about a license which is issued in a normal route by, e.g., purchasing a software application. Temporary-formal license information 11003 is issued by converting a temporary license into a formal license and stores information about a license which is issued as a result of processing requested in step S10008.

In the DB of this embodiment, the plurality of pieces of information described above are managed for each application.

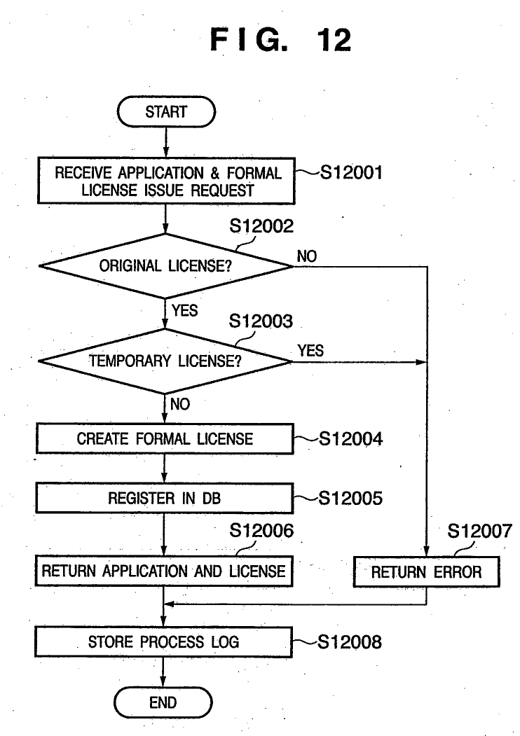

FIG. 12 is a flowchart showing the processing of the license server 1004 when issue of a software application and formal license is requested in step S10007. In step S12001, a software application & formal license issue request command transmitted through the network and accompanying information are received.

In step S12002, the original license information 8002 is acquired from the temporary license 8000 received in step S12001, and search is executed to determine whether the identification information is present in the formal license information 11002. If the identification information is present, the flow advances to step S12003. Otherwise, the flow advances to step S12007. In step S12003, the temporary license information 8003 is acquired from the temporary license 8000 received in step S12001, and search is executed to determine whether the identification information is present in the temporary-formal license information 11003. If the identification information is not present, the flow advances to step S12004. If the identification information is present, the flow advances to step S12007.

In step S12004, a formal license is generated from the temporary license received in step S12001 and the identification information (abcdabcd-45674567-abcdabcd-45674567) of the copying machine 1002. In step S12005, the information of the formal license created in step S12004 is registered in the DB. The information is registered as temporary-formal license information associated with predetermined application information and formal license information.

In step S12006, the application and generated formal license are returned to the request source. They are returned to the formal license acquisition unit 9006 of the copying machine 1002 through the network. In step S12007, an error is returned to notify the user of rejection of formal license issue. Details of the error to be returned are not particularly limited. In step S12008, the log of the above-described steps is stored.

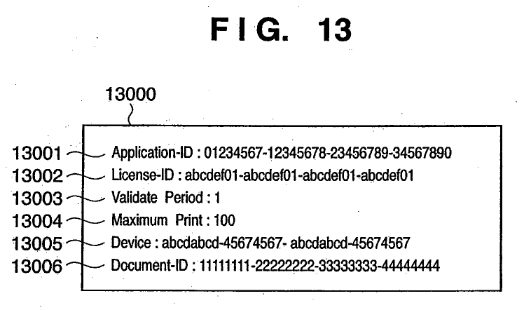

FIG. 13 shows the formal license generated in step S12004. Reference numeral 13001 denotes identification information of a software application corresponding to the application identification information 8001. Information 13002 to uniquely identify the license corresponds to the temporary license 8003. Valid period information 13003 indicates a period during which the application can be used on the basis of the license. In this embodiment, the license is valid for one day. This information corresponds to the temporary license 8004. Printing upper limit information 13004 indicates the upper limit of the printed sheet count of the application based on the license. In this embodiment, the remaining sheet count is 100. This information corresponds to the temporary license 8005. Device identification information 13005 uniquely identifies the copying machine 1002. Information 13006 indicates identification information of image data processible by the license.

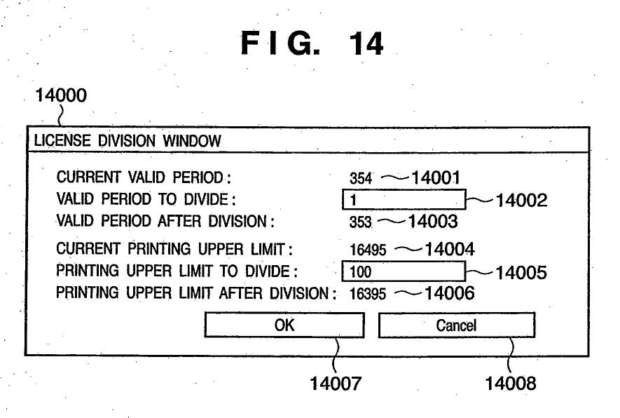

FIG. 14 shows a license division window 14000 to transfer the license contents when the client computer 1005 instructs the copying machine 1001 to store print data on the memory card.

Reference numeral 14001 denotes current valid period contents. That is, the valid period information 6003 is acquired from the license information 6000 of a predetermined application managed by the license management unit 3005 in the copying machine 1001, and displayed. In an input field 14002, the valid period of the license for a software application to be used to print print data stored on the memory card is input. A field 14003 displays a value obtained by subtracting the information of the divided valid period 14002 from the current valid period 14001. Reference numeral 14004 denotes current printing upper limit contents. The printing upper limit information 6004 is acquired from the license information 6000 of a predetermined application managed by the license management unit 3005 in the copying machine 1001, and displayed. In an input field 14005, the printing upper limit of the license for a software application to be used to print print data stored on the memory card is input. A field 14006 displays a value obtained by subtracting the information of the printing upper limit 14005 from the current printing upper limit 14004. A button 14007 is used to determine the settings on the window. Instructing the copying machine 1001 to execute print processing including a temporary license generation instruction corresponding to the contents of the printing upper limit 14005 is determined. A button 14008 is used to cancel the set contents on the window and return to the preceding window.

According to this embodiment, when a print job is to be executed by a device that is different from a device used for creation, execution in the same environment as that for the device used for creation can be implemented, resulting in improved convenience of image forming. Especially, the same environment is implemented by allowing another device to partially use a software application. Since a license is managed, any illicit use can be prevented.

### Second Embodiment

An image forming apparatus according to the second embodiment of the present invention will be described next. In the second embodiment, a job is stored in a memory inserted in the memory slot of a client computer 1005, unlike the first embodiment in which a job is stored in the removable media slot 2100 of the copying machine 1001.

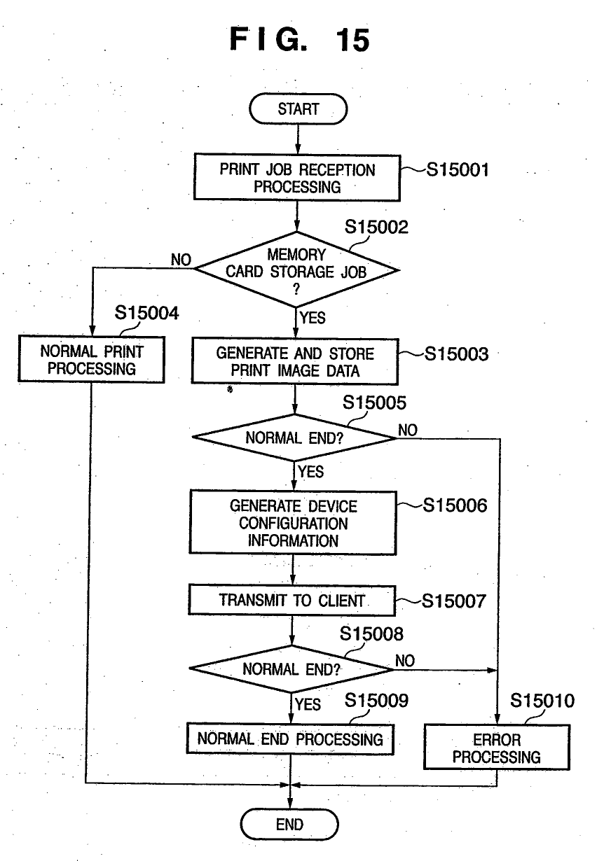

FIG. 15 is a flowchart executed when a copying machine 1001 of this embodiment receives a print job from the client computer 1005. First, in step S15001, a data receiving unit 3001 receives a print job from the client computer 1005.

The flow advances to step S15002 to determine whether the received job instructs storage on a memory card in the client computer 1005. If YES in step S15002, the flow advances to step S15003. Otherwise, a job processing unit 3002 executes normal print processing in step S15004. In step S15003, image data is generated in accordance with the contents of the print job. The flow advances to step S15005 to determine whether image data generation/storage is executed normally. If YES in step S15005, the flow advances to step S15006. Otherwise, the flow advances to step S15009.

In step S15006, device configuration information for print job execution is acquired from a device configuration management unit 3003 and generated. In step S15007, the image data and device configuration information generated in steps S15003 and S15006 are transmitted to the client computer 1005. The flow advances to step S15008 to determine whether the processing in step S15007 is normally ended. If YES in step S15008, the flow advances to step S15009 to execute normal end processing. Otherwise, the flow advances to step S15010 to execute error end processing. The error end processing includes, e.g., deleting various kinds of generated data.

In this embodiment, the data stored on the memory card of the client computer 1005 can be used by the copying machine 1002 and license server 1004 of the first embodiment in the same way.

### Third Embodiment

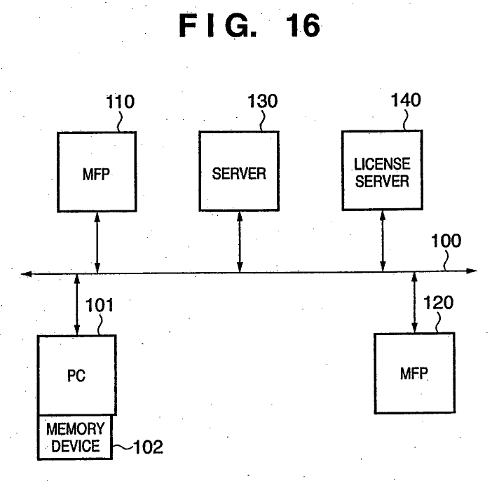

An MFP (Multiple Function Peripheral) as the third embodiment of an image forming apparatus according to the present invention will be described next. FIG. 16 is a view showing a system environment in which the MFP according to this embodiment is used. Referring to FIG. 16, reference numeral 100 denotes a network; 101, a personal computer (PC); 102, a memory device used in connection to the PC; and 110 and 120, MFPs serving as image forming apparatuses. A server 130 manages application software used by the MFPs 110 and 120 and allows download of software as needed. A license server 140 manages the licenses of the application software used by the MFPs 110 and 120.

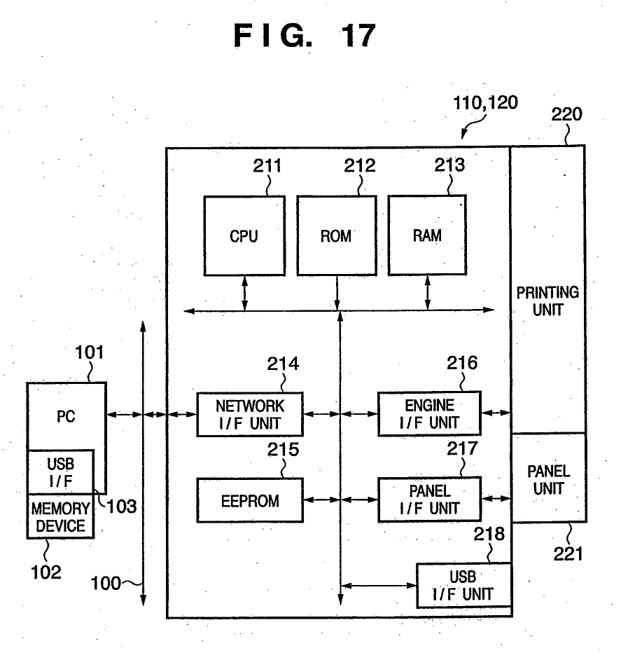

FIG. 17 is a view showing the configuration of the MFPs 110 and 120 and the configuration of the PC 101. Referring to FIG. 17, reference numeral 103 denotes a USB interface serving as a serial interface of the PC 101. A CPU 211 controls the entire MFPs 110 and 120. A ROM 212 stores the operation program of the CPU 211 and font data. A RAM 213 is used by the CPU 211 to operate or used to convert print data sent from the PC 101 into bitmap data and temporarily store it. Reference numeral 214 denotes a network interface unit which communicates with the network 100; and 215, an EEPROM as a nonvolatile memory to store, e.g., the setting information of the MFPs. Reference numeral 216 denotes an engine interface unit which communicates with an engine unit to actually print on paper; 217, a panel interface unit which communicates with the panel unit of the MFP; 218, a USB interface unit which communicates with a connected USB device; 220, a printing unit which actually prints on paper; and 221, a panel unit.

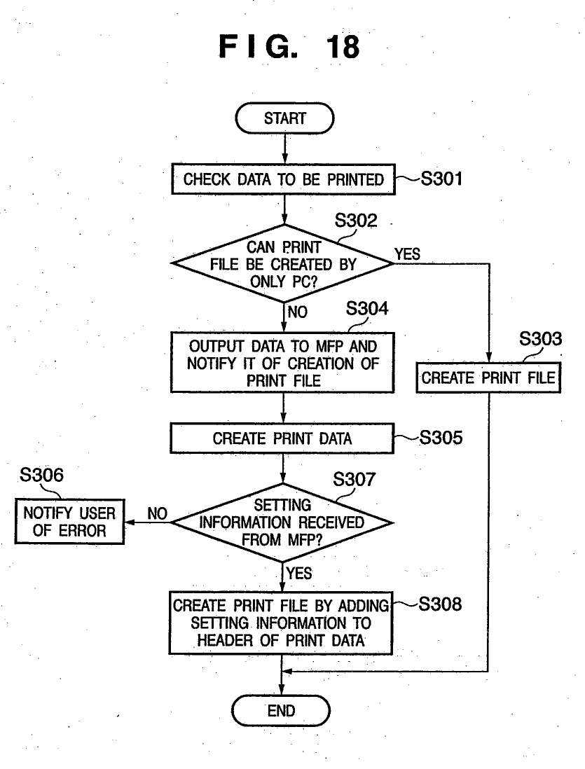

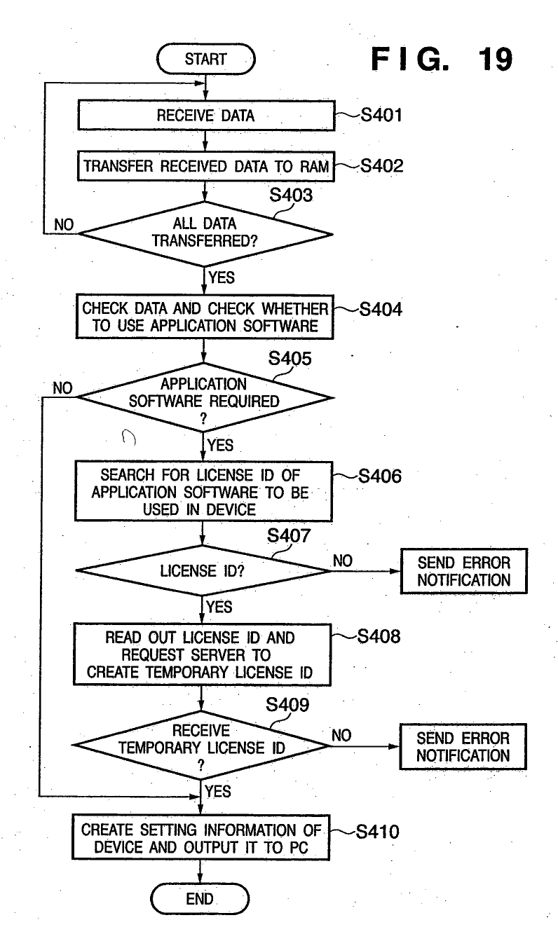

Processing will be described below in which the PC 101 creates print data, the created print data is stored in the memory device 102, and the print data stored in the memory device 102 is printed by the MFP 120. FIG. 18 is a flowchart showing the operation of the PC 101 in this case. FIG. 19 is a flowchart showing the print data creation operation of the MFP 110 in this case.

Data to be printed is designated from the PC 101, and creation of a print file is executed. To process data containing a barcode, the printer driver on the PC 101 checks the data (S301) and determines whether print data of the data can be created by only the PC (S302). If processing is possible in the PC, the PC 101 creates a print file (S303) If processing is impossible in the PC, the data is transmitted to the designated MFP 110, and the MFP 110 is notified that a print file should be created (S304). The PC 101 creates a file from the data transmitted to the MFP 110 (S305).

Referring to FIG. 19, the MFP 110 receives the data through the network interface unit 214 (S401) and notifies the CPU 211 of data reception. The CPU 211 transfers the received data to the RAM 213 through the network interface unit 214 (S402). When all data are transferred to the RAM 213 through the network interface unit 214 (S403), the CPU 211 checks the received data (S404) and checks whether application software processing is necessary (S405). If barcode data is present, the license ID of application software for the barcode data is searched for (S406). If the license ID (barcode print permission) of the application software for the barcode data is present (S407), the CPU 211 reads out the license ID from the EEPROM 215, transmits the license ID to the server 130, and requests creation of temporary license information (temporary license) of the application software (S408). The server 130 sends the license ID to the license server 140 and requests creation of temporary license information. If the license server 140 permits creation, the server 130 creates temporary license ID information and transmits it to the MFP 110 (S410). If the license server 140 does not permit creation, the server 130 notifies the MFP 110 that no temporary license ID information can be created (S409).

Upon receiving the temporary license ID information, the MFP 110 transmits, to the PC 101, device information necessary for printing the transmitted data and, in this case, the temporary license information of the application software of barcode processing as setting information. Setting on the device side, e.g., setting of color processing may be contained in the setting information.

Upon receiving the setting information (S307), the PC 101 creates a file from the data output to the MFP 110 by adding the setting information received from the MFP 110 to the header of the print data (S308). The user copies the created print data to the memory device 102. When notified by the server 130 that no temporary license ID information can be created, the MFP 110 sends an error notification to the user (S306).

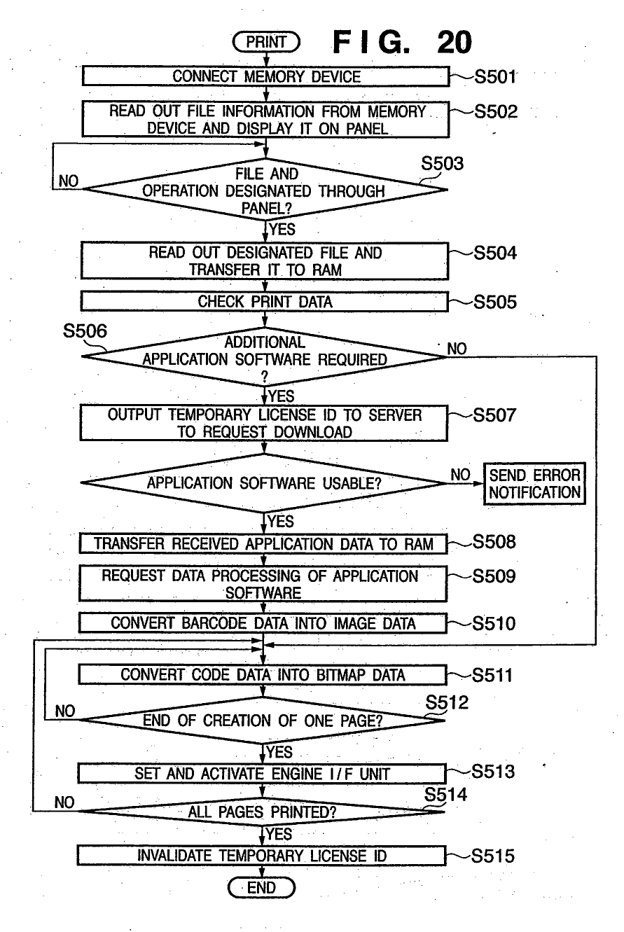

Next, the user connects the memory device 102 storing the print data to the MFP 120. FIG. 20 is a flowchart showing the print operation of the MEFP 120 according to this embodiment.

When the memory device 102 is connected to the MFP 120, i.e., the USB interface unit 218, the CPU 211 detects connection of the device to the USB interface unit 218 (S501), reads out file information from the memory device 102, and displays the readout information on the panel unit 221 through the panel interface unit 217 (S502). When the user designates the data to be printed and designates print processing (S503), the CPU 211 recognizes the input from the panel unit 221 through the panel interface unit 217, reads out the designated file data from the USB interface unit 218, and transfers the file data to the RAM 213 (S504).

The CPU 211 checks the print data (S505) to know, from the header information, application software necessary for printing and checks whether the application software of barcode processing is stored in the device (S506). If the application software is not stored in the device, the temporary license ID information stored in the header is transmitted to the server 130 to request download of the application software (S507). The server 130 sends the temporary license ID information to the license server 140 to confirm whether download is possible. If it is confirmed that the temporary license ID information is correct, a reply is sent to the server 130 to notify it that download is possible. The server 130 sends the data of application software to the MFP 120. Upon receiving the application program through the network interface unit 214, the CPU 211 transfers the software to the RAM 213 (S508).

The CPU 211 requests the downloaded application software to process the stored print data (S509). The CPU 211 executes the application software of barcode processing to convert the barcode data detected in the print data into graphics data (S510) When all data are processed, the processing returns to the normal processing program. Next, the CPU 211 converts the code data of the print data into bitmap data (S511) and stores it on the RAM 213. When bitmap data creation from print data of one page is ended (S512), the CPU 211 sets and activates the engine interface unit 216 (S513).

The engine interface unit 216 reads out the bitmap data stored on the RAM 213 in synchronism with the printing unit 220 and transfers the readout data to the printing unit 220. The printing unit 220 executes printing on the basis of the transferred data. When next page data is present, the CPU 211 converts the code data of the print data into bitmap data and sets and activates the engine interface unit 216. The engine interface unit 216 reads out the bitmap data stored on the RAM 213 in synchronism with the printing unit 220 and transfers the readout data to the printing unit 220. The printing unit 220 executes printing on paper on the basis of the transferred data.

When all data are printed (S514), the CPU 211 rewrites the temporary license ID information in the print data in the memory device 102 connected to the USB interface unit 218 to invalid data (S515).

In this embodiment, barcode data processing has been exemplified as an operation example of application software. However, in, e.g., a color printing apparatus, color processing for each device or decryption of encrypted data can also be considered.

As described above, according to this embodiment, when a print job created by using a first image forming apparatus is to be executed by a second image forming apparatus, the print job can be executed even in the second image forming apparatus in the same environment by the same processing as in the first image forming apparatus.

### Fourth Embodiment

In the fourth embodiment, an operation considering an environment wherein no application software can be downloaded will be described. The system configuration and device configuration are the same as in the third embodiment. The same reference numerals as in the third embodiment denote the same parts in the fourth embodiment, and a description thereof will be omitted.

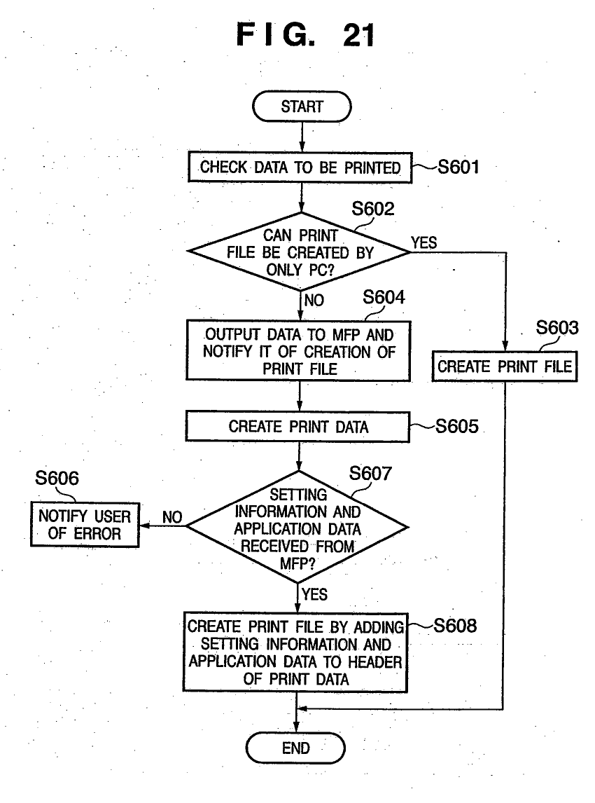

FIG. 21 is a flowchart of the operation of a PC 101 according to this embodiment. Data to be printed is designated from the PC 101, and creation of a print file is executed. To process data containing a barcode, the printer driver on the PC 101 checks the data (S601) and determines whether print data of the data can be created by only the PC (S602). If processing is possible in the PC, the PC 101 creates a print file (S603). If processing is impossible in the PC, the data is transmitted to a designated MF 110, and the MFP 110 is notified that a print file should be created (S604). The PC 101 creates a file from the data transmitted to the MFP 110 (S605).

With the same processing as in FIG. 19, the MFP 110 requests a software application software takeout permission of a server 130.

Upon receiving a software application software takeout permission, the MFP 110 adds device information necessary for printing and the application software to be used to the data transmitted to the PC 101 and transmits the data. In this case, the temporary license information of the application software of barcode processing and the application software are transmitted as setting information (S607). The PC 101 creates a file from the print data output to the MFP 110 by adding the setting information and application software received from the MFP 110 to the header of the print data (S608). The user copies the created print data to a memory device 102.

If use or takeout of the application software is not permitted in a license server 140, the server 130 notifies the MFP 110 of it. In this case, the PC 101 presents an error notification to the user (S606).

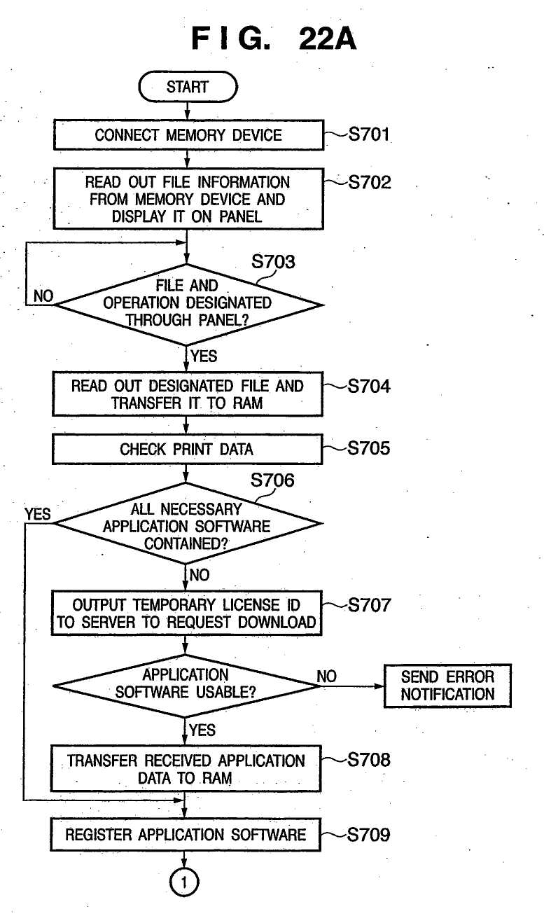

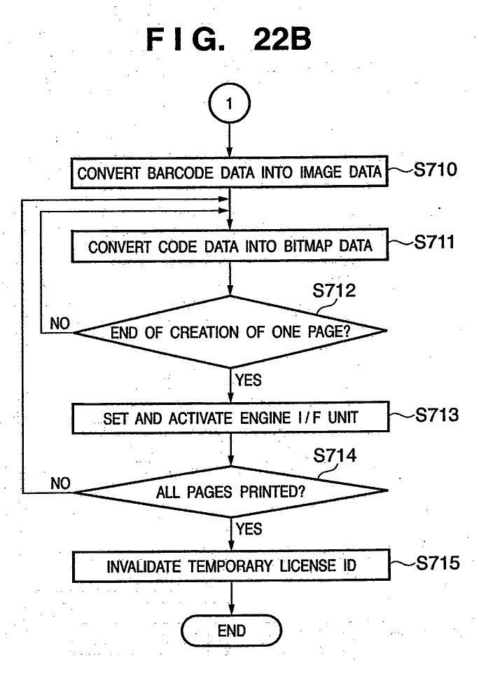

Next, the user connects the memory device 102 storing the above-described print data to the MFP 120. FIGS. 22A and 22B are flowcharts showing the print operation of an MFP 120 according to this embodiment.

When the memory device 102 is connected to a USB interface unit 218, a CPU 211 detects connection of the device to the USS interface unit 218 (S701), reads out file information from the memory device 102, and displays the readout information on a panel unit 221 through a panel interface unit 217 (S702). When the user designates the data to be printed and designates print processing (S703), the CPU 211 recognizes the input from the panel unit 221 through the panel interface unit 217, reads out the designated file data from the USB interface unit 218, and transfers the file data to a RAM 213 (S704).

The CPU 211 checks the print data (S705) to determine whether print processing can be executed by the application software added to the header (S706). If print processing is possible, the application software is registered (S709). If it is determined that additional application software must be downloaded (S706), the temporary license ID information stored in the header is transmitted to the server 130 to request download of the application software (S707).

The server 130 sends the temporary license ID information to the license server 140 to confirm whether download is possible. If it is confirmed that the temporary license ID information is correct, a reply is sent to the server 130 to notify it that download is possible. The server 130 sends the data of application software to the MEFP 120. Upon receiving the application program through a network interface unit 214, the CPU 211 transfers the software to a RAM 213 (S708). The application software is registered (s709).

Referring to FIG. 22B, the CPU 211 executes the registered application software of barcode processing to convert the barcode data detected in the print data into graphics data (S710). When all data are processed, the processing returns to the normal processing program. Next, the CPU 211 converts the code data of the print data into bitmap data (S711) and stores it on the RAM 213. When bitmap data creation from print data of one page is ended (S712), the CPU 211 sets and activates an engine interface unit 216 (S713).

The engine interface unit 216 reads out the bitmap data stored on the RAM 213 in synchronism with a printing unit 220 and transfers the readout data to the printing unit 220. The printing unit 220 executes printing on paper on the basis of the transferred data. When next page data is present, the CPU 211 converts the code data of the print data into bitmap data and sets and activates the engine interface unit 216. The engine interface unit 216 reads out the bitmap data stored on the RAM 213 in synchronism with the printing unit 220 and transfers the readout data to the printing unit 220. The printing unit 220 executes printing on paper on the basis of the transferred data.

When all data are printed (S714), the CPU 211 rewrites the temporary license ID information in the print data in the memory device 102 connected to the USB interface unit 218 to invalid data (S715).

According to this embodiment, when a print job created by using a first image forming apparatus is to be executed by a second image forming apparatus, the print job can be executed even in the same environment by the same processing as in the first image forming apparatus even when the second image forming apparatus is not connected to the network or server.

### Fifth Embodiment

A case will be described as the fifth embodiment of the present invention in which application software license management is executed by different servers. The same reference numerals as in the above-described third embodiment denote the same parts or process steps in the fifth embodiment, and a description thereof will be omitted.

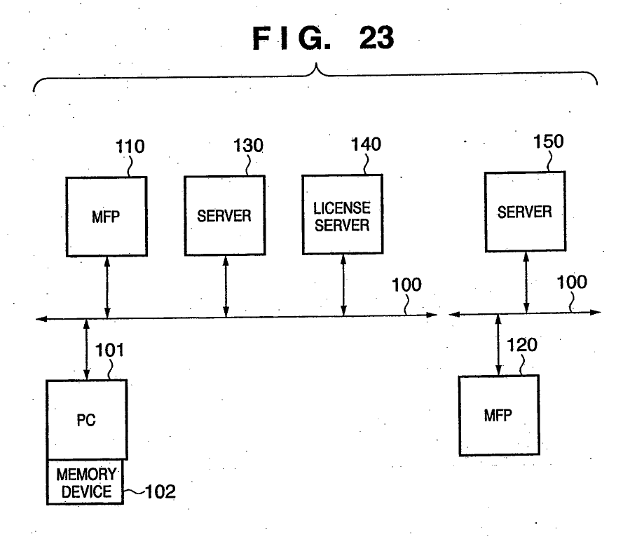

FIG. 23 is a view showing the configuration of a system according to this embodiment. Referring to FIG. 23, reference numeral 100 denotes a network; 101, a personal computer (PC); 102, a memory device used in connection to the PC; and 110 and 120, MFPs serving as printing apparatuses. A server 130 manages application software used by the MFPs 110 and 120 and allows download of software as needed. A license server 140 manages the licenses of the application software used by the MFPs 110 and 120. A server 150 manages application software used by the MFP 120 and allows download of software as needed.

Data to be printed is designated from the PC 101, and creation of a print file is executed. To process data containing a barcode, the printer driver on the PC 101 checks the data (S301) and determines whether print data of the data can be created by only the PC (S302). If processing is possible in the PC, the PC 101 creates a print file (S303). If processing is impossible in the PC, the data is transmitted to the designated MFP 110, and the MFP 110 is notified that a print file should be created (S304). The PC 101 creates a file from the data transmitted to the MFP 110 (S305).

The MFP 110 receives the data through a network interface unit 214 (S401) and notifies a CPU 211 of data reception. The CPU 211 transfers the received data to a RAM 213 through the network interface unit 214 (S402). When all data are transferred to the RAM 213 through the network interface unit 214 (S403), the CPU 211 checks the received data (S404) and checks whether application software processing is necessary (S405). If barcode data is present, the CPU 211 determines that application software processing is necessary and searches for the license ID of application software (S406).

If the license ID of the application software for the barcode data is present (S407), the CPU 211 reads out the license ID from an EEPROM 215, transmits the license ID to the server 130, and requests creation of temporary license information of the application software (S408). The server 130 sends the license ID to the license server 140 and requests creation of temporary license information. If the license server 140 permits creation, the server 130 creates temporary license ID information and transmits it to the MFP 110 (S410). If the license server 140 does not permit creation, the server 130 notifies the MFP 110 that no temporary license ID information can be created (S409).

Upon receiving the temporary license ID information, the MFP 110 transmits, to the PC 101, device information necessary for printing the transmitted data by a printing apparatus and, in this case, the temporary license information of the application software of barcode processing as setting information. Upon receiving the setting information (S307), the PC 101 creates a file from the data output to the MFP 110 by adding the setting information received from the MFP 110 to the header of the print data (S308). The user copies the created print data to the memory device 102. If the PC 101 receives no setting information, an error notification is sent to the user (S306).

Next, the user connects the memory device 102 storing the above-described print data to the MFP 120. When the memory device 102 is connected to the MFP 120, i.e., a USB interface unit 218, the CPU 211 detects connection of the device to the USB interface unit 218 (S501), reads out file information from the memory device 102, and displays the readout information on a panel unit 221 through a panel interface unit 217 (S502). When the user designates the data to be printed and designates print processing (S503), the CPU 211 recognizes the input from the panel unit 221 through the panel interface unit 217, reads out the designated file data from the USB interface unit 218, and transfers the file data to the RAM 213 (S504).

The CPU 211 checks the print data (S505) to know, from the header information, application software necessary for printing and checks whether the application software of barcode processing is stored in the device (S506). If the application software is not stored in the device, the temporary license ID information stored in the header is transmitted to the server 150 to request download of the application software (S507). The server 150 confirms the transmitted temporary license ID information. If it is confirmed that the license is correct, the server 150 sends the data of application software to the MFP 120. If it cannot be determined that the license is correct, an error notification is sent. Upon receiving the application program through the network interface unit 214, the CPU 211 transfers the software to the RAM 213 (S508).

The CPU 211 requests the downloaded application software to process the stored print data (S509). The CPU 211 executes the application software of barcode processing to convert the barcode data detected in the print data into graphics data (S510). When all data are processed, the processing returns to the normal processing program. Next, the CPU 211 converts the code data of the print data into bitmap data (S511) and stores it on the RAM 213. When bitmap data creation from print data of one page is ended (S512), the CPU 211 sets and activates an engine interface unit 216 (S513).

The engine interface unit 216 reads out the bitmap data stored on the RAM 213 in synchronism with a printing unit 220 and transfers the readout data to the printing unit 220. The printing unit 220 executes printing on paper on the basis of the transferred data. When next page data is present, the CPU 211 converts the code data of the print data into bitmap data and sets and activates the engine interface unit 216. The engine interface unit 216 reads out the bitmap data stored on the RAM 213 in synchronism with the printing unit 220 and transfers the readout data to the printing unit 220. The printing unit 220 executes printing on paper on the basis of the transferred data.

When all data are printed (S514), the CPU 211 rewrites the temporary license ID information in the print data in the memory device 102 connected to the USB interface unit 218 to invalid data (S515).

According to this embodiment, when a print job created by using a first image forming apparatus is to be executed by a second image forming apparatus, the print job can be executed in the same environment by the same processing as in the first image forming apparatus even when the second image forming apparatus does not belong to the same network as the first image forming apparatus.

### Other Embodiment

The embodiments of the present invention have been described above in detail. The present invention may be applied to a system including a plurality of devices or an apparatus including a single device.

The present invention is also achieved even by supplying a program which implements the functions of the above-described embodiments to the system or apparatus directly or from a remote site and causing the system or apparatus to read out and execute the supplied program codes. Hence, the program code itself, which is installed in a computer to implement the functional processing of the present invention by the computer, is also incorporated in the technical scope of the present invention.

In this case, the program can take any form such as an object code, a program to be executed by an interpreter, or script data to be supplied to the OS as long as the functions of the program can be obtained.

As a recording medium to supply the program, for example, a floppy® disk, hard disk, optical disk, magnetooptical disk, MO, CD-ROM, CD-R, CD-RW, magnetic tape, nonvolatile memory card, ROM, or DVD (DVD-ROM or DVD-R) can be used.

As another program supply method, a client computer may be connected to a homepage on the Internet by using a browser in the client computer, and the computer program itself of the present invention or a compressed file containing an automatic install function may be downloaded from the homepage to a recording medium such as a hard disk. The program code contained in the program of the present invention may be divided into a plurality of files, and the files may be downloaded from different homepages. That is, a WWW server which causes a plurality of users to download a program file that causes a computer to implement the functional processing of the present invention is also incorporated in the claim of the present invention.

The program of the present invention may be encrypted, stored in a storage medium such as a CD-ROM, and distributed to users. Any user who satisfies predetermined conditions may be allowed to download key information for decryption from a homepage through the Internet, execute the encrypted program by using the key information, and install the program in the computer.

The functions of the above-described embodiments are implemented not only when the readout program is executed by the computer but also when, e.g., the OS running on the computer performs part or all of actual processing on the basis of the instructions of the program.

The functions of the above-described embodiments are also implemented when the program read out from the recording medium is written in the memory of a function expansion board inserted into the computer or a function expansion unit connected to the computer, and the CPU of the function expansion board or function expansion unit performs part or all of actual processing on the basis of the instructions of the program.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2005-193080 filed on Jun. 30, 2005, which is hereby incorporated by reference herein in its entirety.

What is claimed is:

1. An image forming method of executing image forming by using a software application which requires a license for use, comprising the steps of:
issuing a temporary license for a print job which requires the application, in a first apparatus;
storing the temporary license in a storage medium of the first apparatus;
reading out the temporary license from the storage medium and causing a second apparatus to acquire a license from a server in exchange for the temporary license; and
executing the print job in the second apparatus by using the application whose license is acquired in said reading step.

2. The method according to claim 1, wherein
in the storage step, the temporary license is added to the print job and stored in the storage medium, and
in the license acquisition step, the print job and the temporary license are read out from the storage medium, and the license is acquired from the server.

3. An image forming system including a first image forming apparatus and a second image forming apparatus, wherein
said first image forming apparatus comprises
a software application usable on condition of a first license,
generation means for generating a print job to be implemented by using the application, and
storage means for storing, in a storage medium, a temporary license for the print job generated by said generation means; and
said second image forming apparatus comprises
means for reading out the temporary license from the storage medium,
means for requesting a second license necessary for using the application of a server by using the temporary license, and
means for acquiring the second license and executing the print job by using the application.

4. The system according to claim 3, wherein said storage means stores the temporary license and the print job in the storage medium.

5. The system according to claim 4, wherein said storage means further stores setting information for use of the application in the storage medium together with the print job.

6. The system according to claim 4, wherein said storage means further stores the application itself in the storage medium together with the print job.

7. The system according to claim 4, wherein
the first license contains a use limit value to define a use limit of the application, and
a part of the use limit value contained in the first license is transferred to the second license.

8. The system according to claim 7, wherein said first image forming apparatus further comprises setting means for setting the use limit value of the first license to be transferred to the second license.

9. The system according to claim 4, wherein the second license permits only use of the application in said second image forming apparatus.

10. The system according to claim 4, wherein the second license permits use of the application only in execution of the print job.

11. The system according to claim 4, wherein said second image forming apparatus further comprises means for installing the application by using the second license.

12. The system according to claim 11, wherein when the storage medium is removed from said second image forming apparatus, the installed application is uninstalled.

13. The system according to claim 4, wherein said first image forming apparatus further comprises means for encrypting the temporary license by using a predetermined key.

14. The system according to claim 4, wherein said second image forming apparatus further comprises:
determination means for, when the temporary license is read out, determining whether a software application corresponding to the temporary license is present in said second image forming apparatus; and
means for, when the software application corresponding to the temporary license is not present, transmitting an application request command and the temporary license to the server, acquiring the application and the second license from the server, and installing the application.

15. An image forming apparatus used in an image forming system of claim 4.

16. A driver program stored in a computer readable medium to instruct a first image forming apparatus used in an image forming system of claim 4 to output a print job to a storage medium, causing a computer to execute the step of setting contents to be transferred from contents of a first license to a second license in instructing output of image data.

17. An image forming apparatus comprising:
a software application usable on condition of a first license;
generation means for generating a print job to be implemented by using the application;
storage means for storing, in a storage medium, a temporary license for the print job generated by said generation means;
license acquisition means for reading out the temporary license from the storage medium;
means for requesting a second license necessary for using the application of a server by using the temporary license; and
means for acquiring the second license and executing the print job by using the application.

18. The apparatus according to claim 17, wherein
said storage means adds the temporary license to the print job and stores the temporary license in the storage medium, and
said license acquisition means reads out the print job and the temporary license from the storage medium and acquires the license from the server.

19. A driver program stored in a computer readable medium to cause an image forming apparatus to execute image forming by using a software application which requires a license for use, causing a computer to execute the steps of:
requesting said image forming apparatus to issue a temporary license for a print job which requires the application;
receiving the temporary license issued in response to the request from said image forming apparatus; and
storing the received temporary license in a storage medium.

20. The driver according to claim 19, wherein
in the temporary license issue step, said image forming apparatus is requested to issue the temporary license in storing, in the storage medium, the print job which requires the application, and
in the storage step, the print job and the received temporary license are stored in the storage medium.

21. An information processing apparatus for causing an image forming apparatus to execute image forming by using a software application which requires a license for use, comprising:
temporary license request means for requesting said image forming apparatus to issue a temporary license for a print job which requires the application;
reception means for receiving the temporary license issued in response to the request from said image forming apparatus; and
storage means for storing the received temporary license in a storage medium.

22. The apparatus according to claim 21, wherein
said temporary license request means requests said image forming apparatus to issue the temporary license in storing, in the storage medium, the print job which requires the application, and
said storage means stores the print job and the received temporary license in the storage medium.

23. A license management server comprising:
a license identification information database which manages a software application, license identification information to identify a license issued by normal license issue processing, and license identification information to identify a license generated from a temporary license; and
generation means for generating a formal license from the temporary license,
wherein upon receiving a software application request command from an image forming apparatus connected through a network, said generation means determines whether original license identification information and the temporary license identification information, which are contained in the temporary license sent in accordance with the application request command, are present in said license identification information database,
only when the original license identification information is registered in said license identification information database, and the temporary license identification information is not registered, said generation means generates a formal license having the same identification information as the temporary license, and
said generation means stores the identification information of the generated formal license in said license identification information database and returns the formal license to the image forming apparatus together with the application.

24. The server according to claim 23, wherein said license identification information database of the license management server further manages individual identification information of the image forming apparatus which has transmitted the formal license.
